(19) United States
(12) Patent Application Publication
(10) Pub. No.: US 2002/0180749 A1
(43) Pub. Date: Dec. 5, 2002

(54) Method of bilinear texture filtering

(76) Inventors: Chien-Chung Hsiao, Peng Hu County (TW); Teo Chin Chiang, Hsin Chu (TW); Kow-Woei Yeh, Miao Li County (TW)

Correspondence Address: BIRCH STEWART KOLASCH & BIRCH, PO BOX 747, FALLS CHURCH, VA, 22040-0747, US

(21) Appl. No.: 09/871,101

(22) Filed: Jun. 1, 2001

(51) Int. Cl. G09G 5/00

(52) U.S. Cl. 345/586

(57) ABSTRACT

A method of bilinear texture filtering comprising the steps of reading information of a pixel; calculating texture coordinate for the pixel according to the information of the pixel, the texture coordinate having integral portion and fractional portion; determining a pair of texels according to the texture coordinate; reading values of the pair of texel from texture; and computing the color of the pixel according to the values of the pair of texels by a weighted average of the fractional portion of the texture coordinate.

### FIELD OF INVENTION

The present invention relates to a texture filtering method of computer graphic systems, and more particularly to a bilinear texture filtering method to achieve fast and cost-effective accessing by only selecting a pair of texels.

### BACKGROUND OF INVENTION

In the process of computer graphic system, each pixel's color value has to be derived from texture by mapping, which is called texture filtering. In computer generated 3D images, texture filtering is a very important technique. Texture usually is a two dimensional array of color values which are individually called texels. Each texel has own address which is formed with a column and row numbers named as S and T. Typically, each texel's texture coordinate is in the range of 0.0 to 1.0. The coordinates also represent texel center corresponding to a texture-mapping coordinate according to the texture mapping. In 3D applications, the texture coordinate can be assigned to any vertex of any primitive. When the computer graphics system renders a primitive, texture coordinates are calculated and the corresponding texels are accessed from memory for each pixel of the primitive. For instance, in 3D applications a object that has a wood grain pattern can be created by mapping a wooden texture onto surfaces of the 3D object.

FIG. 1 is the texture processing in computer graphic system, wherein the texture is stored in a texture storage unit 10 such as a hard drive. When a rendering engine requires the texture for texture mapping, the texture is sent to local memory II of the graphics accelerator through a bus. The texture processing unit 12 then reads the texture from the local memory 11 and performs texture-mapping process. The exiting texture mapping methods include nearest point sampling, bilinear texture filtering, and trilinear texture filtering.

FIG. 2A is a diagram illustrating the nearest point sampling technique. In the diagram, the closest texel is sampled to represent the pixel's color. This texture filtering is one of low-overhead method after computed. However, this technique will cause undesired graphic artifacts in the displayed image. FIG. 2B illustrates the bilinear texture filtering. As FIG. 2B shown, the bilinear texture filtering computes a weighted average from the four adjacent texels. FIG. 2C illustrates the trilinear texture filtering (also called mipmap texture filtering). A mipmap is a sequence of textures, each of which is a progressively lower resolution representation of the same image. The size of each image in the mipmap is one half of the previous level in each dimension. In the trilinear texture filtering, the bilinear texture filtering is performed on the two nearest mipmaps to generate two nearest values. Therefore, a final pixel value is determined in accordance with the level of detail (LOD) by interpolating linearly between the two nearest values. For example, the final pixel value in FIG. 2C is equal to:

0.25(a*w1+b*w2+c*w3+d*w4)+0.75(e*w5+f*w6+g*w7+h*w8)

wherein the w1, w2, w3, w4, w5, w6, w7 and w8 represent the weight of each texel.

According to the above description, four or eight memory accesses are required when the bilinear filtering or trilinear filtering is performed respectively. Typically, a texture cache is exploited to reduce memory bandwidth requirement for texture filtering in 3D graphics hardware design. For bilinear or trilinear texture filtering, the cache must have four or eight output ports to provide texels for one pixel in one clock cycle. Unfortunately, the area of the cache increases with the number of the I/O ports and becomes unacceptable. The 3D graphics hardware can use multipass texture filtering to achieve the same effects, if desired texels cannot be obtained in one clock cycle. However, the performance of graphics system will be sacrificed. It is therefore desirable to provide a texture filtering technique that eliminates graphics artifacts without large amounts of memory accesses.

### SUMMARY OF INVENTION

In view of the foregoing problems, an object of the present invention is to provide a cost-effective bilinear texture filtering method which reduces the texel accesses from texture memory in a computer graphic system.

The other object of the present invention is to provide a cost-effective bilinear texture filtering method which reduces the texel accesses from texture memory by selecting a pair of texels of texture to determine the pixel's color in a computer graphic system.

The further object of the present invention is to provide a cost-effective bilinear texture filtering method which chooses a pair of texels to calculate pixel's color by the pixel's shape corresponding to the texture in a computer graphic system.

For achieving those above object, the present invention, a cost-effective bilinear texture filtering method, comprises the steps of:

reading a pixel's information;

calculating texture coordinate of the pixel corresponding to the texture according to the pixel's information, the texture coordinate having integral portion and fractional portion;

determining a pair of texels according to the texture coordinate;

reading values of the pair of texels from the texture; and

computing pixel's color according to the texel pair's value by a weighted average of the fractional portion of texture coordinate.

### BRIEF DESCRIPTION OF DRAWING

FIG. 1 is a diagram of a texture processing system.

FIG. 2A is diagram of a nearest point sampling of the prior art.

FIG. 2B is a diagram of a bilinear texture filtering of the prior art.

FIG. 2C is a diagram of a trilinear texture filtering of the prior art.

FIG. 3 is the separated form of 2×2 texture block of the first embodiment.

FIG. 4 is the separated form of 2×2 texture block of the second embodiment.

FIG. 5 is an example of texel random selection.

FIG. 6 is another texel selection embodiment of the present invention.

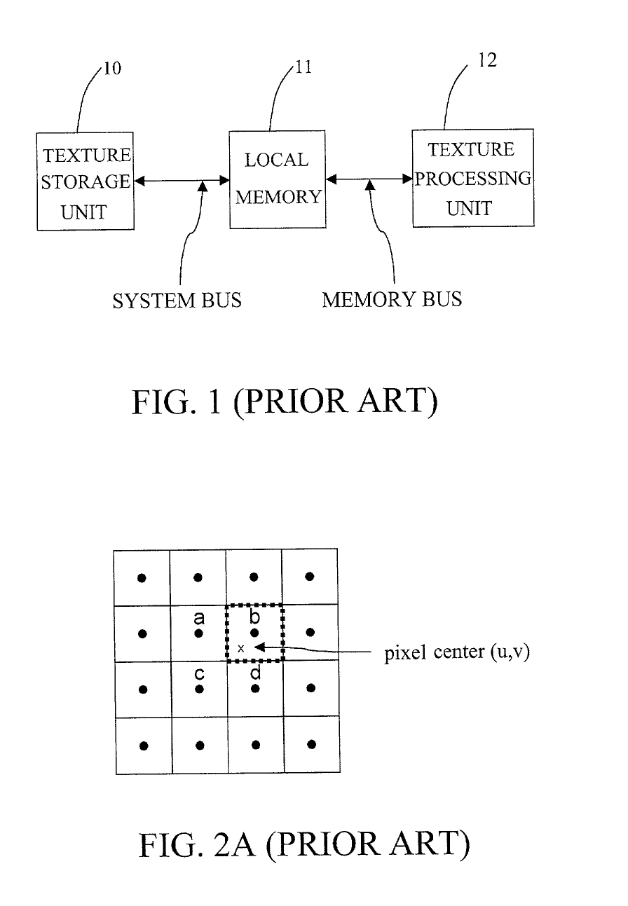

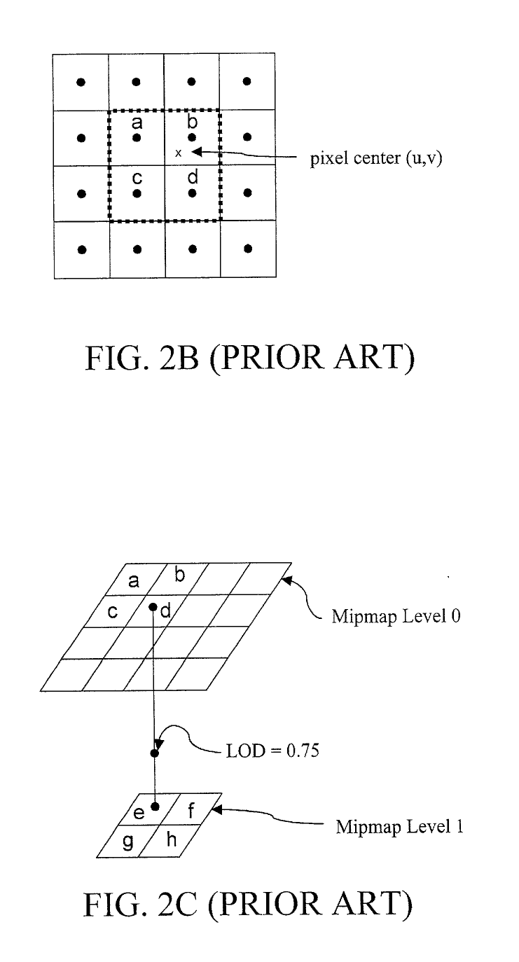

### DETAIL DESCRIPTION OF INVENTION

The present invention will be apparent from the following detailed description, which proceeds with reference to the accompanying drawings, wherein the same references relate to the same elements.

The prior art bilinear texture filtering is to select four adjacent texels, which are the most closed to the texture coordinate, from the texture. Due to the memory bandwidth and performance of the graphic system, the bilinear texture filtering of the present invention only selects two texels from the texture to compute the color. The performance of the prior art, therefore, can be effectively reached.

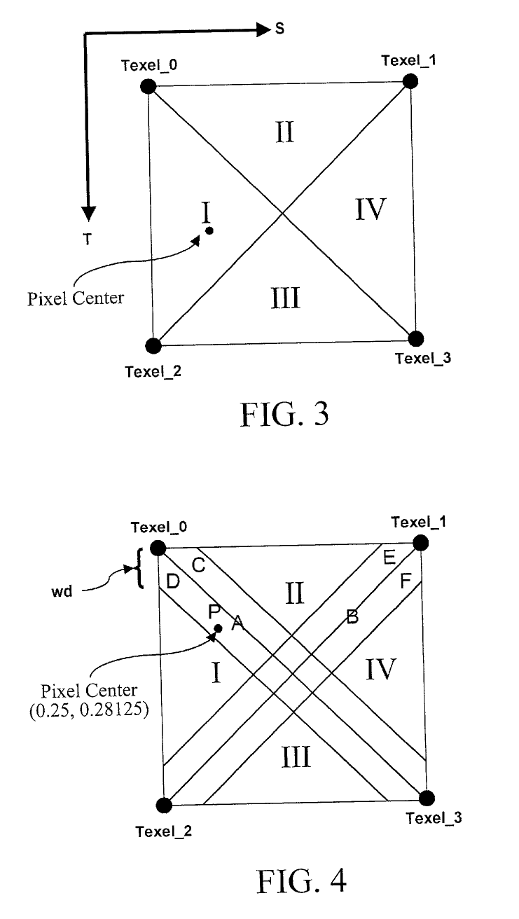

FIG. 3 is a region area diagram of 2×2 texture block of the first embodiment. Wherein, texel_{—}0, texel_{—}1, texel_{—}2 and texel_{—}3 are the four nearest texels to the center of a pixel, and the texture block is divided into 4 regions: I (left), II (top), III (bottom) and IV (right). If a pixel falls in region I which means that the texel_{—}0 and the texel_{—}2 are significantly affected, the texel_{—}0 and the texel_{—}2 are selected to calculate the pixel's color value. If a pixel falls in region II which means that the texel_{—}0 and the texel_{—}1 are significantly affected, the texel_{—}0 and the texel_{—}1 are selected to calculate the pixel's color value. If a pixel falls in region III which means that the texel_{—}2 and the texel_{—}3 are significantly affected, the texel_{—}2 and the texel_{—}3 are selected to calculate the pixel's color value. If a pixel falls in region IV which means that the texel_{—}1 and the texel_{—}3 are significantly affected, the texel_{—}1 and the texel_{—}3 are selected to calculate the pixel's color value. Therefore, the bilinear texture filtering of the present invention only need to get 2 texels in a texture to calculate the pixel's color, and the time of reading texels of the rendering engine can be efficiently reduced.

The following description is the method to calculate which region the pixel will fall in. Suppose that the size of the texture is TH (height)*TW (width). If the center of each pixel has a corresponding coordinate (u, v) in texture, wherein u and v are in the range of 0˜1, u and v are converted into real coordinate, S and T, of texture, wherein S=u*TW, T=v*TH. S and T include integral portion WS and WT and fractional portion ws and wt. The integral portion WS and WT are used to determine the 4 closet texels, texel_{—}0, texel_{—}1, texel_{—}2 and texel_{—}3. The fractional portion ws and wt are used to determine the corresponding region for the pixel. The corresponding regions are:

Region I: ws<wt, ws+wt<1, selecting the texel_{—}0 and the texel_{—}2.

Region II: ws>=wt, ws+wt<1, selecting the texel_{—}0 and the texel_{—}1.

Region III: ws<wt, ws+wt>=1, selecting the texel_{—}2 and the texel_{—}3.

Region IV: ws>=wt, ws+wt>=1, selecting the texel_{—}1 and the texel_{—}3.

Therefore, when ws and wt are calculated by the rendering engine, the region for the pixel is also determined. Therefore a suitable pair of texels can be selected to calculate the pixel's color. When the corresponding value of texels are gotten, the pixel's color can be calculated according ws, wt, and the corresponding value of texels. For instance, if a pixel falls in region I, the pixel's color value equals to (1-wt)* D(texel_{—}0)+wt*D(texel_{—}2). If a pixel falls in region II, the pixel's color value equals to (1-ws)* D(texel_{—}0)+ws*D(texel_{—}1). If a pixel falls in region III, the pixel's color value equals to (1-ws)* D(texel_{—}2)+ws*D(texel_{—}3). If a pixel falls in region IV, the pixel's color value equals to (1-ws)* D(texel_{—}1)+ws*D(texel_{—}3). Wherein, D(texel_{—}0), D(texel_{—}1), D(texel_{—}2) and D(texel_{—}3) are the value of the texel_{—}0, texel_{—}1, texel_{—}2 and texel_{—}3.

FIG. 4 is a region area diagram of 2×2 texture block of the second embodiment which divides the texture block into 10 regions. According to the mechanism of the first embodiment of the present invention, the artifact may occur if a group of pixels fall in the same region. In the same time, a magnification of a texture can result in many pixels being mapped to the same region. A block effect is caused because a group of pixels fall in the same region. Therefore, FIG. 4 is another embodiment disclosed by the present invention. The 2×2 texels block is divided into 10 regions: I, II, III, IV, A, B, C, D, E and F, wherein region A, B, C, D, E and F are defined as indistinct regions. The 4 indistinct regions are most closed to texel_{—}0 [symbol] texel_{—}1 [symbol] texel_{—}2 [symbol] texel_{—}3 of rendered pixel which are unable to be apparently distinguished. Therefore, in the present invention, when a pixel falls in the indistinct regions: A, B, C, D, E or F, two texels are randomly selected from texel_{—}0z,900 texel_{—}1 [symbol] texel_{—}2 [symbol] texel_{—}3 in order to reduce the block effect. The following is the selecting method of 10 regions:

Region I: ws<wt−wd, ws+wt<1, selecting texel_{—}0 and texel_{—}2.

Region II: ws>=wt, ws+wt<1, selecting texel_{—}0 and texel_{—}1.

Region III: ws<wt, ws+wt>=1, selecting texel_{—}2 and texel_{—}3.

Region IV: ws>=wt, ws+wt>=1, selecting texel_{—}1 and texel_{—}3.

Region A: ws=wt.

Region B: ws+wt=1.

Region C: ws>wt and ws<=wt+wd.

Region D: ws<wt and ws>=wt−wd.

Region E: ws+wt<1 and ws+wt+wd<1.

Region F: ws+wt>1 and ws+wt−wd>1.

Wherein, wd is width of the indistinct region. For instance, when a rendered pixel falls in diagonal A, the distances from the texel_{—}1 and the texel_{—}2 to the rendered pixel are same and unable to be distinguished. When a rendered pixel falls in diagonal B, the distances from the texel_{—}0 and the texel_{—}3 to the rendered pixel are same and unable to be distinguished. When a rendered pixel falls in region C and D, texel_{—}1 and texel_{—}2 are closed to the rendered pixel and unable to be distinguished. When rendered pixel falls in region E and F, texel_{—}0 and texel_{—}3 are closed to the rendered pixel and unable to be distinguished. Therefore, if a rendered pixel falls in indistinct regions, the pair of texel is selected randomly or selected by a predefined method.

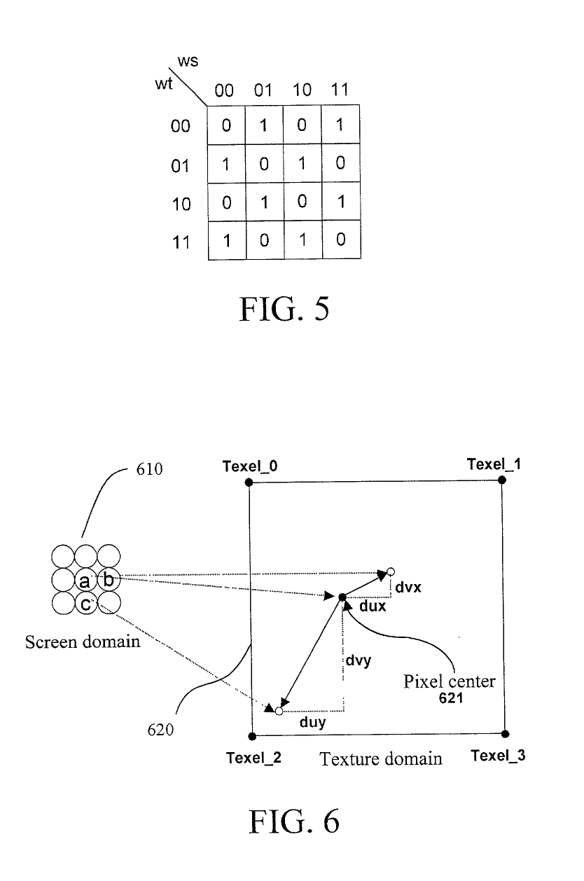

FIG. 5 is an example of texel random selection method. For instance, if the fractional portion (ws, wt) of the coordinate of a rendered pixel's center is (0.25, 0.28125), the rendered pixel P falls in region D as shown in FIG. 4. If ws and wt are 5-bit fraction, the ws and wt of the rendered pixel P are 01000 and 01001, respectively. Two least significant bits of ws and wt are selected to perform randomization process. According to FIG. 5 in this example, if the output is “0”, the selection method is same as FIG. 3. If the output is “1”, hence, the pixel center is mirrored to other regions. For instance, 00(ws) and 01(wt) of the rendered pixel P is “1”, hence, the pixel is mirrored to region II.

FIG. 6 is another texel selection embodiment of the present invention. The first embodiment and the second embodiment choose texels according to the coordinate of rendered pixel. In this embodiment, the selection of texels is according to the corresponding shape onto the texture of the rendered pixel. When a rendered pixel 610 from a primitive is map onto a texture 620, the rendered pixel's corresponding shape is adjusted according to dimension of the texture 620. Therefore, when a pair of texels is selected according to the corresponding shape of the rendered pixel on the texture 620, the affect to the pair of texels can efficiently reflect. If the length of the corresponding shape of the rendered pixel is greater than the width of the corresponding shape of the rendered pixel on the texture, the nearest vertical pair of texels are selected. Otherwise, the nearest horizontal pairs of texels are selected. Referring to FIG. 6, the corresponding shapes of pixels a, b, c on the texture are decided by comparing the distance of dux, dvx, duy and dvy. If the maximum of dux and duy is greater than the maximum of dvx and dvy, the nearest horizontal pair of texels are selected. Otherwise, the nearest vertical pair of texels are selected. The selecting method of the shape of the rendered pixel on the texture is not limited on the above description. For instance, if the maximum of dux and duy is greater than maximum of dvx and dvy, the farthest horizontal pair of texels can be selected. Otherwise, the farthest vertical pair of texels can be selected.

In the meantime, the present invention can be applied to the trilinear texture filtering. In the general trilinear texture filtering, bilinear filtering is performed on the two nearest mipmaps to generate two values. Then interpolate linearly between the two values to determine a final pixel value according to the value of LOD. The bilinear texture filtering of the present invention is performed on the two nearest mipmaps, then interplates linearly between the two values to determine a final pixel value according to the value of LOD.

What is claimed is:

1. A method of bilinear texture filtering comprising the steps of:
reading information of a pixel;
calculating texture coordinate for the pixel according to the information of the pixel, the texture coordinate having integral portion and fractional portion;
determining a pair of texels according to the texture coordinate;
reading values of the pair of texel from texture; and
computing the color of the pixel according to the values of the pair of texels by a weighted average of the fractional portion of the texture coordinate.

2. The method as claimed in claim 1, wherein the step of determining a pair of texels is to select two texels most closed to the texture coordinates as the pair of texels.

3. The method as claimed in claim 2, wherein the step of determining a pair of texels is to randomly select two texels from four most closed to the texture coordinates as the pair of texels, when the difference between the distance of the texel thirdly closed to the texture coordinate and the distance of the texel secondly closed to the texture coordinates to the texture coordinate is smaller than a predefined value.

4. The method as claimed in claim 1, wherein the step of determining a pair of texels is to select two texels as the pair of texels according to the corresponding shape of the pixel onto the texture.

5. The method as claimed in claim 4, wherein if the width of the corresponding shape is greater than length of the corresponding shape, the vertical pair of texels most closed to the texture coordinate are selected as the pair of texels, otherwise, the horizontal pair of texels most closed to the texture coordinate are selected as the pair of texels.

6. The method as claimed in claim 2, wherein the step of computing pixel color is to compute the pixel color in accordance with a weighted average of the values of the pair of texels and the fractional portion of texture horizontal axis coordinate, if the horizontal pair of texels are selected, and to compute the pixel color in accordance with a weighted average of the values of the pair of texels and the fractional portion of texture vertical axis coordinate, if the vertical pair of texels are selected.

7. The method as claimed in claim 3, wherein the step of computing pixel color is to compute the pixel color in accordance with a weighted average of the values of the pair of texels and the fractional portion of texture horizontal axis coordinate, if the horizontal pair of texels are selected, and to compute the pixel color in accordance with a weighted average of the values of the pair of texels and the fractional portion of texture vertical axis coordinate, if the vertical pair of texels are selected.

8. The method as claimed in claim 4, wherein the step of computing pixel color is to compute the pixel color in accordance with a weighted average of the values of the pair of texels and the fractional portion of texture horizontal axis coordinate, if the horizontal pair of texels are selected, and to compute the pixel color in accordance with a weighted average of the values of the pair of texels and the fractional portion of texture vertical axis coordinate, if the vertical pair of texels are selected.

9. A method of trilinear texture filtering comprising the steps of:
reading information of a pixel;
calculating a first value of a first layer texture of the pixel according to the method as claimed in claim 1;
calculating a second value of a second layer texture of the pixel according to the method as claimed in claim 1; and
calculating the color of the pixel according to the first value, the second value, and weighted proportion of the distance from the pixel to the first layer texture and the second layer texture.
